(19) United States
(12) Patent Application Publication
(10) Pub. No.: US 2003/0214681 A1
(43) Pub. Date: Nov. 20, 2003

(54) Facsimile system and method

(76) Inventor: David G. Bohan, Eagle, ID (US)

Correspondence Address: HEWLETT-PACKARD COMPANY, Intellectual Property Administration, P.O. Box 272400, Fort Collins, CO, 80527-2400, US

(21) Appl. No.: 10/147,771

(22) Filed: May 16, 2002

(51) Int. Cl. H04N 1/32; H04N 1/00

(52) U.S. Cl. 358/468; 358/442

(57) ABSTRACT

The present disclosure relates to a system and method for manipulating data to be faxed. In one arrangement, the system and method pertain to obtaining data to be included in a facsimile document and automatically determining the total number of pages of the facsimile document. By way of example, the data may be obtained from multiple data sources. In other arrangements, the system and method can further pertain to presenting the facsimile document to a user for review prior to the step of facilitating transmission of the facsimile document.

### FIELD OF THE INVENTION

The present disclosure generally relates to facsimile generation and transmission. More particularly, the disclosure relates to a system and method with which facsimile data can be collected to automatically determine the number of pages of a facsimile document and/or to permit the user to review the facsimile document prior to its transmission.

### BACKGROUND OF THE INVENTION

Today, there are many different facsimile devices that are designed for use in conjunction with a host, such as a personal computer (PC). Although there are peripheral facsimile machines, often the devices have multiple functionalities including, for instance, printing, copying, scanning, faxing, emailing, etc. Examples of such devices include so-called multiple function peripherals (MFPs) and all-in-one devices.

When used to fax, the facsimile device obtains data that is to be faxed that can comprise, for example, scan data obtained from scanning a hard copy document or data transmitted to the device from one or more applications running on the host. Typically, software executed on the host can be used to generate a cover page that is added to the data to be faxed to compete the facsimile document. As is known in the art, this cover page normally includes information about the sender (e.g., name, phone number, facsimile number) as well as information about the intended recipient (e.g., name, phone number, facsimile number). In addition to this information, the cover page usually includes an indication of the total number of pages that the facsimile document comprises so that the recipient can ensure that each page that was intended to be transmitted did in fact arrive.

The page number indication is normally manually entered by the user prior to transmission of the facsimile document. This task, although relatively straightforward, can be tedious in that, prior to faxing the document to the recipient, the user must count the number of pages of the document and increase the count by one to account for the cover page. In addition, it may be difficult for the user to determine the number of pages that the facsimile document will have where multiple sources of data are used to compose the facsimile document. For instance, where the facsimile document incorporates a hard copy document that was scanned by the device, a document from a word processing application, and images from an imaging application, it can be difficult for the user to keep track of the total number of pages that the complete facsimile document will comprise.

In addition to the above-noted drawbacks, a further disadvantage with conventional systems is that the user cannot review the facsimile document prior to its transmission. Where multiple data sources are used to create the facsimile document, the user will not be certain as to the arrangement of the various data within the document. Even where the facsimile document only comprises scan data obtained by scanning a hard copy document, the user cannot view the data prior to its transmission to ensure that it is adequately clear to send to the intended recipient.

In view of the above, it can be appreciated that it would be desirable to have a system and method with which facsimile data can be collected to automatically determine the number of pages that the facsimile document includes and/or to permit the user to review the facsimile document prior to its transmission.

### SUMMARY OF THE INVENTION

The present disclosure relates to a system and method for manipulating data to be faxed. In one arrangement, the system and method pertain to obtaining data to be included in a facsimile document and automatically determining the total number of pages of the facsimile document. By way of example, the data may be obtained from multiple data sources. In other arrangements, the system and method can further pertain to presenting the facsimile document to a user for review prior to the step of facilitating transmission of the facsimile document.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a schematic view of an example system in which the invention can be implemented.

FIG. 2 is a schematic view of a transmission device shown in FIG. 1.

FIG. 3 is a schematic view of a computing device shown in FIG. 1.

FIG. 4 is a flow diagram that illustrates the general operation of a fax control program of the computing device of FIG. 3.

FIGS. 5A and 5B provide a flow diagram of a first detailed example of operation of the fax control program.

FIGS. 6A and 6B provide a flow diagram of a second detailed example of operation of the fax control program.

### DETAILED DESCRIPTION

As noted above, disclosed is a facsimile system and method with which facsimile data can be collected to automatically determine the number of pages of a facsimile document and/or to permit the user to review the facsimile document prior to its transmission. To facilitate description of the system and method, an example system is first discussed with reference to the figures. Although this system is described in detail, it will be appreciated that this system is provided for purposes of illustration only and that various modifications are feasible without departing from the inventive concept. After the example system has been described, examples of operation of the system will be provided to explain the manners with which facsimile data can be manipulated so as to automatically determine page length and permit user previewing of facsimile documents.

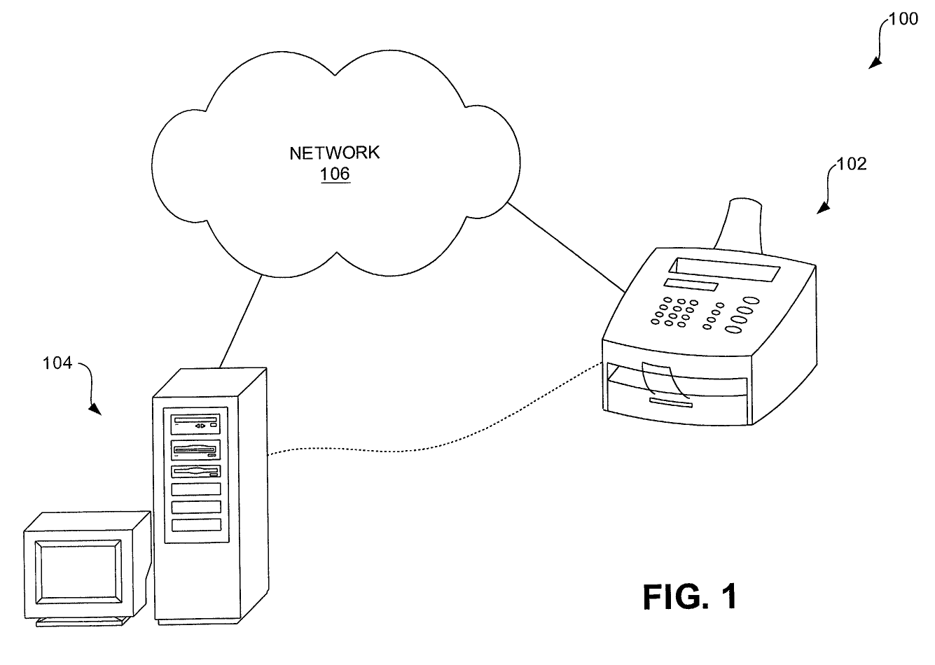

Referring now in more detail to the drawings, in which like numerals indicate corresponding parts throughout the several views, FIG. 1 illustrates an example system 100. As indicated in this figure, the system 100 generally comprises a transmission device 102 that is capable as operating as a peripheral device and/or as a stand-alone (walk-up) device. Generally speaking, the transmission device 102 comprises a device that is capable of faxing documents to a destination device. In addition, the transmission device 102 may comprise other functionalities such as printing, copying, scanning, emailing, etc. and therefore can, by way of example, be configured as a multifunction peripheral (MFP) or all-in-one device.

In addition to the transmission device 102, the system 100 can include one or more computing devices 104. The computing devices 104 comprise any device that is capable of transmitting data to and/or receiving data from the transmission device 102. By way of example, the computing device 104 can comprise a personal computer (PC). Although a PC is identified in FIG. 1 and discussed herein, it will be appreciated that the computing device 104 could, alternatively, comprise another type of computing device including, for instance, a notebook computer, a personal digital assistant (PDA), a mobile telephone, etc.

As is further identified in FIG. 1, the transmission device 102 and the computing device 104 can, optionally, be connected to a network 106 that typically comprises one or more sub-networks that are communicatively coupled to each other. By way of example, these networks can include one or more local area networks (LANs) and/or wide area networks (WANs). Indeed, in some embodiments, the network 106 may comprise a set of networks that forms part of the Internet. As is depicted in FIG. 1, the computing device 104 can be directly connected to the transmission device 102. Such an arrangement is likely in a home environment in which the user does not have a home network, or in an office environment where the transmission device 102 is used as a local “convenience” device. In either scenario, communications can be facilitated with a direct electrical and/or optical connection, or through wireless communication (e.g., radio frequency (RF), infrared (IR)).

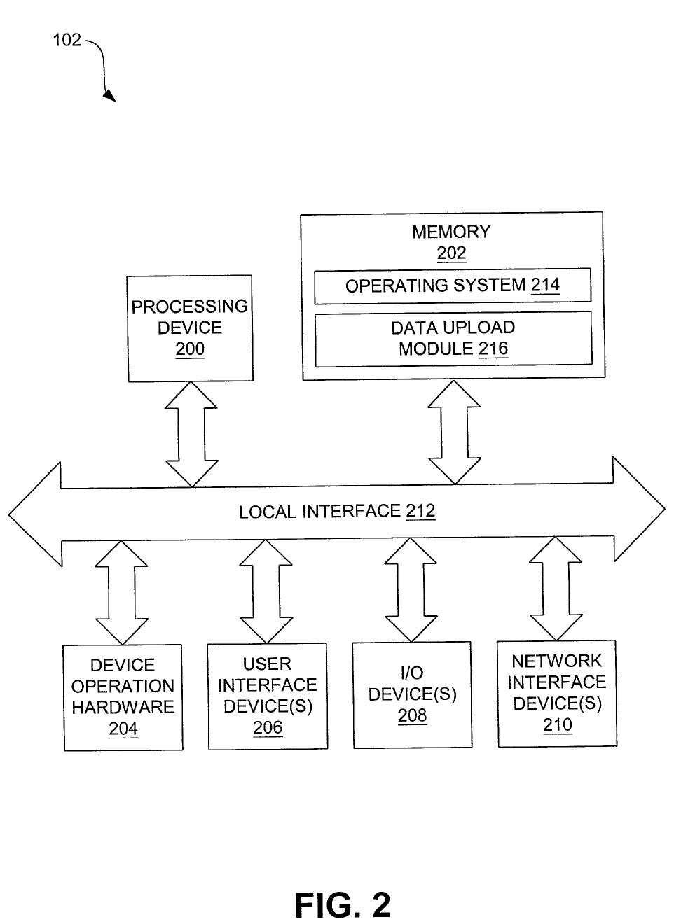

FIG. 2 is a schematic view illustrating an example architecture for the transmission device 102 shown in FIG. 1. As indicated in FIG. 2, the transmission device 102 can comprise a processing device 200, memory 202, device operation hardware 204, one or more user interface devices 206, one or more input/output (I/O) devices 208, and one or more network interface devices 210. Each of these components is connected to a local interface 212 that, by way of example, comprises one or more internal buses. The processing device 200 is adapted to execute commands stored in memory 202 and can comprise a general-purpose processor, a microprocessor, one or more application-specific integrated circuits (ASICs), a plurality of suitably configured digital logic gates, and other well known electrical configurations comprised of discrete elements both individually and in various combinations to coordinate the overall operation of the transmission device 102.

The device operation hardware 204 comprises the various components with which the core functionalities of the transmission device 102 are facilitated. For 16z: example, this hardware 204 comprises the various components that are needed to transmit data across telephone lines. Typically, the operation hardware 204 comprises a scanning mechanism that facilitates faxing of hard copy documents. The one or more user interface devices 206 typically comprise interface tools with which the device settings can be changed and through which the user can directly communicate information and commands to the transmission device 102. By way of example, the user interface devices 206 comprise one or more function keys and/or buttons with which the operation of the transmission device 102 can be controlled and a plurality of numeric and/or alphabetic keys or buttons that can be used to input information. In addition, the user interface devices 206 can comprise a display with which text and/or graphics can be presented to the user. Such a display can, for instance, comprise a liquid crystal display (LCD), a light emitting diode (LED) display, plasma screen, etc. Optionally, the display can be touch-sensitive such that user commands and selections can be entered with the display.

With further reference to FIG. 2, the one or more I/O devices 208 are adapted to facilitate connection of the transmission device 102 to another device, such as the computing device 104, and may therefore include one or more serial, parallel, small computer system interface (SCSI), universal serial bus (USB), IEEE 1394 (e.g., Firewire™), and/or personal area network (PAN) components. The network interface devices 210 comprise the various components that are used to transmit and/or receive data over the network 106, where the transmission device is adapted for this form of communication. By way of example, the network interface devices 210, when provided, include a device that can communicate both inputs and outputs, for instance, a network card, a modulator/demodulator (e.g., modem), wireless (e.g., radio frequency (RF)) transceiver, a telephonic interface, a bridge, a router, etc.

The memory 202 includes various software and/or firmware programs including an operating system 214 and an data upload module 216. The operating system 214 contains the various commands used to control the general operation of the transmission device 102. As is described below, the data upload module 216 comprises software and/or firmware that facilitates transmission of scan data to a host, such as computing device 104.

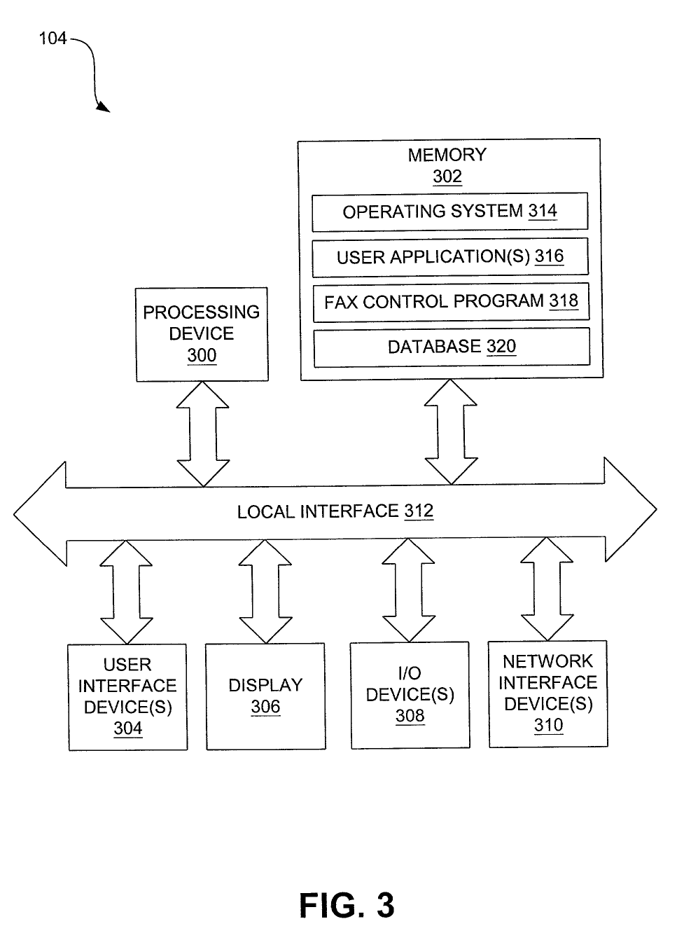

FIG. 3 is a schematic view illustrating an example architecture for the computing device 104 shown in FIG. 1. As indicated in FIG. 3, the computing device 104 can comprise a processing device 300, memory 302, one or more user interface devices 304, a display 306, one or more I/O devices 308, and one or more networking devices 310, each of which are connected to a local interface 312. The processing device 300 can include any custom made or commercially available processor, a central processing unit (CPU) or an auxiliary processor among several processors associated with the computing device 104, a semiconductor based microprocessor (in the form of a microchip), or a macroprocessor. The memory 302 can include any one of a combination of volatile memory elements (e.g., random access memory (RAM, such as DRAM, SRAM, etc.)) and nonvolatile memory elements (e.g., ROM, hard drive, tape, CDROM, etc.).

The one or more user interface devices 304 comprise those components with which the user can interact with the computing device 104. For example, where the computing device 104 comprises a PC, these components can comprise a keyboard, mouse, and/or track ball. Where the computing device 104 comprises a handheld device (e.g., PDA, mobile telephone), these components can comprise function keys or buttons, a touch-sensitive screen, etc. The display 306 can comprise a computer monitor or plasma screen for a PC, or a liquid crystal display (LCD) for a handheld device. The one or more I/O devices 308 and the one or more network interface devices 310 operate and can have similar configuration to the like-named components described above with relation to FIG. 2.

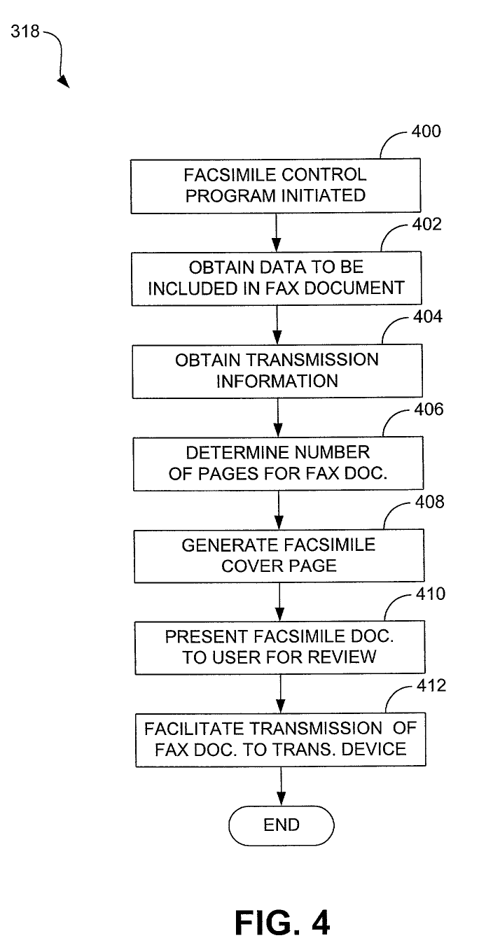

The memory 302 normally at least comprises an operating system 314, one or more user applications 316, and a facsimile (fax) control program 318. The operating system 314 controls the execution of other software and provides scheduling, input-output control, file and data management, memory management, and communication control and related services. The facsimile control program 318 can be used to control the operation of the transmission device 102. In addition, the control program 318 can collect data from various sources to compose a facsimile document. Through this collection of data, the program 318 con determine the total number of pages for the facsimile document as well as present the facsimile document to the user for review. The operation of the program 318 is described in greater detail with relation to FIGS. 4-6 below. The memory 302 can further comprise a database 320 that contains information about the user such as the user's identity, facsimile numbers of various potential facsimile recipients, etc.

Various software and/or firmware programs have been described herein. It is to be understood that these programs can be stored on any computer-readable medium for use by or in connection with any computer-related system or method. In the context of this document, a computer-readable medium is an electronic, magnetic, optical, or other physical device or means that can contain or store a computer program for use by or in connection with a computer-related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. A “computer-readable medium” can be any means that can store, communicate, propagate, or transport the program for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium can even be paper or another suitable medium upon which a program is printed, as the program can be electronically captured, via for instance optical scanning of the paper or other medium, then compiled, interpreted or otherwise processed in a suitable manner if necessary, and then stored in a computer memory.

An example system 100 having been described above, operation of the system will now be discussed. In the discussion that follows, flow diagrams are provided. It is to be understood that any process steps or blocks in these flow diagrams represent modules, segments, or portions of code that include one or more executable instructions for implementing specific logical functions or steps in the process. It will be appreciated that, although particular example process steps are described, alternative implementations are feasible. Moreover, steps may be executed out of order from that shown or discussed, including substantially concurrently or in reverse order, depending on the functionality involved.

Referring to FIG. 4, general operation of the facsimile control program 318 will be described. Beginning with block 400, the facsimile control module 318 is initiated. This initiation can occur in a variety of different ways. For example, initiation can occur when a user opens the program 318 on the computing device 104 by, for instance, selecting an appropriate icon presented to the user with the display 306. In another case, initiation can occur when data are delivered from a data source (e.g., user application 316 or transmission device 102) for arrangement as a facsimile document.

Irrespective of the nature of the initiation, the control program 318 can obtain data to be included in the facsimile document that will be transmitted to a recipient, as indicated in block 402. At this point, the control program 318 can obtain the transmission information from the user, as identified in block 404. This transmission typically includes the name of the intended recipient, the destination facsimile number, the telephone number of the recipient, and so forth. By way of example, the user can be prompted for this information by the control program 318.

After, or before, the transmission information has been obtained, the facsimile control program 318 determines the total number of pages that the facsimile document includes, as indicated in block 406. Where a cover page is to be included with the transmission, this number will normally include the cover page. Assuming a facsimile cover page is to be used, the cover page can be generated, as identified in block 408. In that the total number of pages of the facsimile document is now known, the facsimile control program 318 can automatically complete a “number of pages” field of the cover page, if desired.

Next, as indicated in block 410, the facsimile control program 318 can present the facsimile document to the user for review. This presentation can, for instance, comprise a preview similar to print previews provided by known word processing applications prior to printing a document. Assuming the facsimile document to be acceptable, the facsimile control program 318 then facilitates the transmission of the facsimile document to the transmission device 102, as indicated in block 412, so that the transmission device can fax the document to the intended recipient.

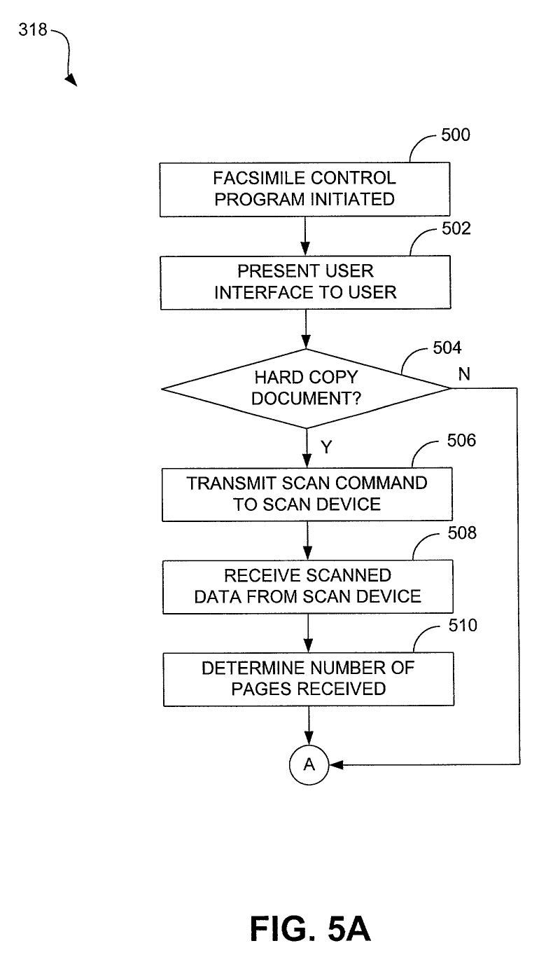

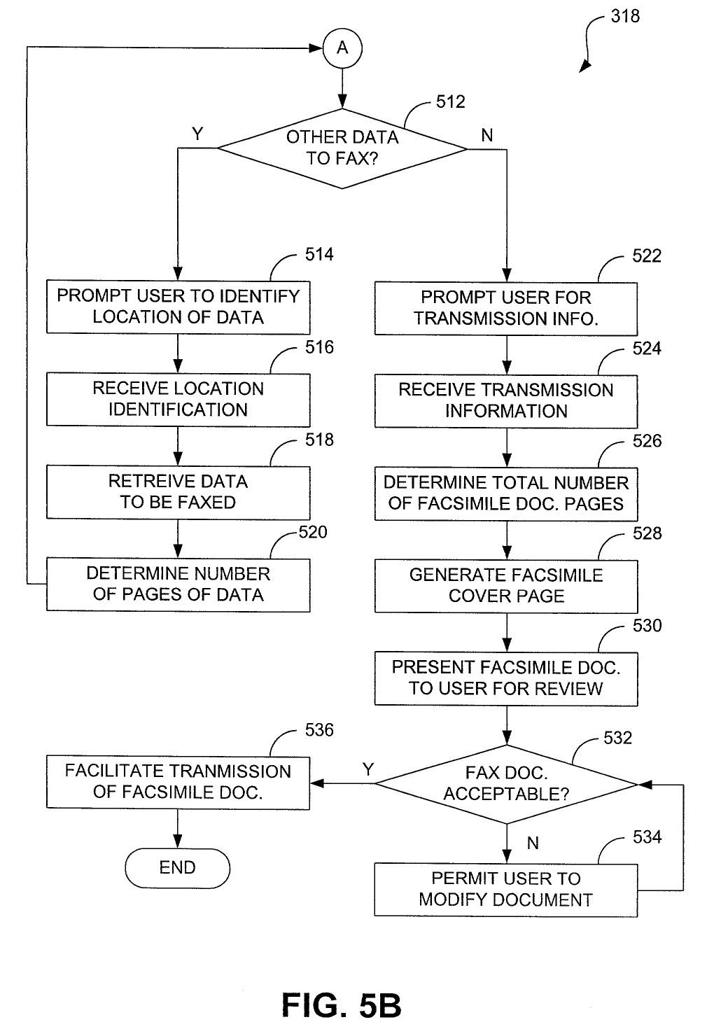

With reference now to FIGS. 5A and 5B, illustrated is a detailed example of operation of the facsimile control program 318 in manipulating facsimile data. Specifically, illustrated is a mode of operation in which the user initiates the faxing process by first accessing the control program 318 using the computing device 104.

Beginning with block 500 of FIG. 5A, the facsimile control program 318 is initiated. In this example, initiation occurs in response to user input via the computing device 104. For instance, as identified above, initiation can occur upon user selection of an appropriate icon associated with the control program 318. Once initiated, the program 318 presents a user interface to the user, as identified in block 502. By way of example, this interface comprises a graphical user interface (GUI) that is presented to the user with the display 306. Referring next to decision element 504, it can be determined, with reference to commands received from the user with the user interface, whether a hard copy document is to be scanned to provide facsimile data that will be used to create the facsimile document. If not, i.e., another source of data is to be used to create the facsimile document, flow continues over to decision element 512 of FIG. 5B described below. If, on the other hand, a hard copy document is to be scanned, the facsimile control program 318, as indicated in block 506, transmits a scan command to the scan device, which typically comprises the transmission device 102 where the transmission device is capable of such functionality. In an alternative arrangement, however, the scan device can comprise a separate device such as a conventional scanner.

Once the scan command has been issued, the facsimile control program 318 waits for the scan device to scan the document and, ultimately, the program receives the scanned data from the scan device, as indicated in block 508. Normally, transmission of the data to the control program 318 is facilitated by appropriate code of the scan device, for instance, data upload module 216 of the transmission device 102. After the data has been received, the control program 318 determines the number of pages of data that have been received, as indicated in block 510, and this value is stored for later reference.

With reference now to decision element 512 of FIG. 5B, it can then be determined whether other data are to be faxed and, more particularly, included as part of the facsimile document. If more data are to be added to the facsimile document, flow continues to block 514 at which the user can be prompted to identify the location of these data. To facilitate this identification, the control program 318 can present the user with a browsing tool with which the user can select the desired data from a list of files stored on the computing device 104. By way of example, the data can comprise one or more word processing documents and/or image documents.

Once the location identification has been received in block 516, the facsimile control program 318 can retrieve the data, as indicated in block 518. After the data has been retrieved in this manner, the control program 318 determines the number of pages that comprise those data, as indicated in block 520 and, where applicable, add the number to the previous tally. Flow then returns to decision element 512 where it is determined whether any more data are to be included in the facsimile document.

If no further data are to be provided in the facsimile document, flow continues to block 522 at which the user is prompted for the various transmission information. Again, this transmission information typically comprises the name of the intended recipient, the facsimile number, the intended recipient's phone number, etc. Once the user provides this information, for example by inputting the information into various fields of the user interface using the user interface devices 304, the transmission information is received, as indicated in block 524.

At this point, or at any previous time at which all the data to be included in the facsimile document have been identified, the facsimile control program 318 determines the total number of facsimile document pages, as indicated in block 526. Again, this total normally includes the cover page where a cover page will be transmitted. Assuming a cover page is to be transmitted, it is generated by the facsimile control program 318, as indicated in block 528. This cover page includes an indication of the total number of pages that comprise the facsimile document.

Next, with reference to block 530, the facsimile control program 318 can, if desired by the user, present the facsimile document to the user in electronic form for the user's review. Again, the document can be presented in similar manner to a print preview such that the user can view a what-you-see-is-what-you-get (WYSIWYG) representation of the facsimile prior to faxing. Once viewed, it can be determined whether the document is acceptable for faxing, as indicated in decision element 532. If not, flow continues to block 534 at which the user is permitted to modify the document in some manner. The nature of this modification can take many different forms. By way of example, the modification can comprise deletion of one or more pages, addition of new pages, reordering of the existing pages, rescanning of various pages at a different resolution, and so forth.

Once the modifications are performed, flow returns to decision element 532 and, if the facsimile document is then considered acceptable, flow continues on to block 536 at which the facsimile control program 318 facilitates transmission of the now complete facsimile document to the transmission device 102 for faxing.

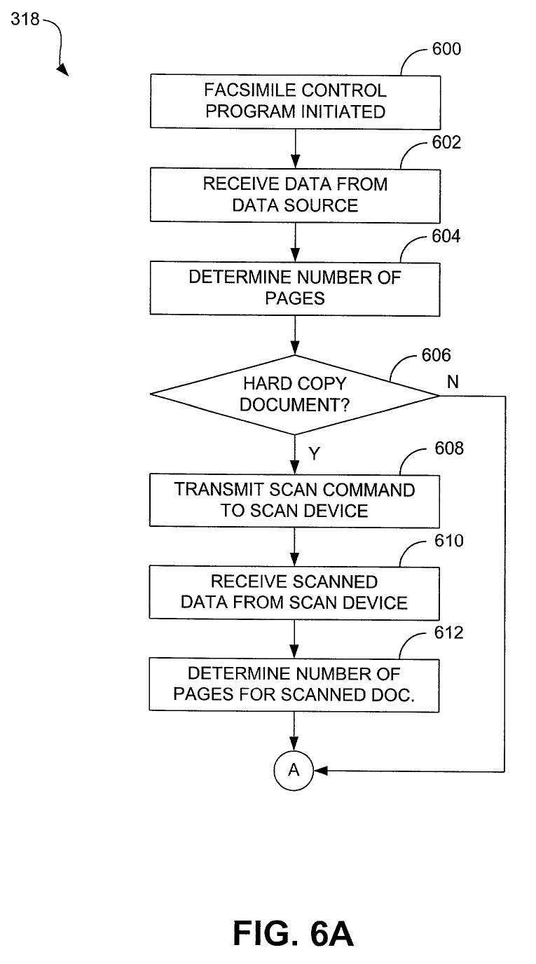

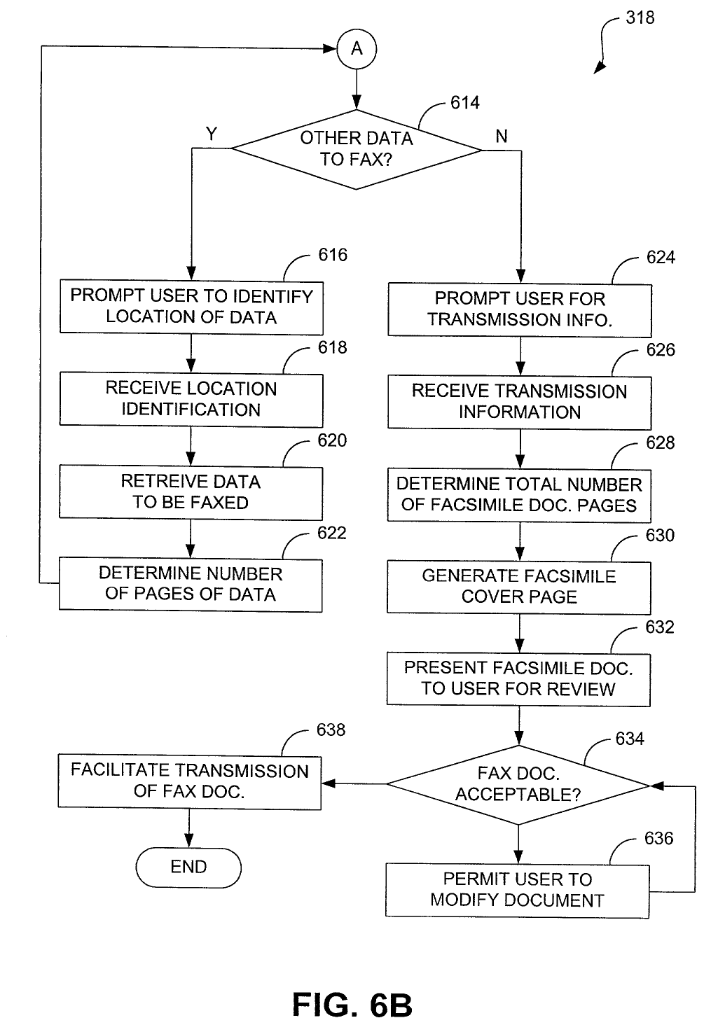

FIGS. 6A and 6B illustrate a further example of operation of the facsimile control program 318 in manipulating facsimile data. In this example, the user initiates the faxing process by providing facsimile data to the control program 318 using a user application 316 of the computing device 104, or by initiating scanning of a hard copy document with an appropriate scan device, such as transmission device 102.

Beginning with block 600 of FIG. 5A, the facsimile control program 318 is initiated by, as identified in block 602 receiving data from a given data source. Where the data source comprises a user application 316 that executes on the computing device 104, the data can have been received in response to a “print” command entered by the user in that application. In such a case, the various pages of the application document are rendered into an image file that is provided to the facsimile control program 318. If the data source comprises the scan device (e.g., transmission device 102), the data can have been received from the device after a scan had been initiated by the user by, for instance, selecting an appropriate button of the device user interface. In such a case, the transmission of the scanned data to the control program 318 can have been facilitated by the data upload module 216 of the transmission device 102.

Once the data are received, the facsimile control program 318 can determine the number of pages that have been received, as indicated in block 604. At this point, flow is similar to that described above with reference to FIGS. 5A and 5B. Accordingly, with reference to decision element 606, it can be determined whether a (or a further) hard copy document is to be scanned. If not, flow continues to decision element 614 of FIG. 6B described below. However, if a (or a further) hard copy document is to be scanned, the facsimile control program 318 transmits a scan command to the scan device (block 608), receives the scanned data from the scan device (block 610), and determines the number of pages of data that have been received (block 612).

Turning to decision element 614 of FIG. 6B, it can then be determined whether other data are to be included as part of the facsimile document. If so, flow continues to block 616 at which the user can be prompted to identify the location of these data, to block 618 at which the location identification is received, block 620 at which the facsimile control program 318 retrieves the data, and then to block 622 at which the control program determines the number of pages that comprises those data.

If no further data are to be included in the facsimile document, the user is prompted for the transmission information (block 624), the transmission information is received (block 626), and the total number of facsimile document pages are determined (block 628). At this point, the facsimile cover page can be generated (block 630) and the complete facsimile document presented to the user for review (block 632). If not deemed acceptable, flow continues to block 636 at which the user is permitted to modify the document in some manner. Once the document is acceptable to the user, flow continues to block 638 at which the facsimile control program 318 facilitates transmission of the complete facsimile document to the transmission device 102 for faxing.

While particular embodiments of the invention have been disclosed in detail in the foregoing description and drawings for purposes of example, it will be understood by those skilled in the art that variations and modifications thereof can be made without departing from the scope of the invention as set forth in the following claims.

What is claimed is:

1. A method for manipulating data to be faxed to an intended recipient, comprising:
obtaining data to be included in a facsimile document; and
automatically determining the total number of pages of the facsimile document.

2. The method of claim 1, wherein the step of obtaining data comprises obtaining data from multiple data sources.

3. The method of claim 2, wherein the step of obtaining data comprises receiving scanned data from a transmission device.

4. The method of claim 2, wherein the step of obtaining data comprises obtaining data from a user application running on a computing device.

5. The method of claim 2, wherein the step of automatically determining the total number of pages comprises automatically determining the total number of pages of all data received from the multiple data sources.

6. The method of claim 1, further comprising generating a facsimile cover page.

7. The method of claim 6, further comprising automatically including an indication of the number of pages the facsimile document has on the facsimile cover page.

8. The method of claim 1, further comprising presenting the facsimile document to the user for review prior to transmitting the facsimile document.

9. The method of claim 8, further comprising permitting the user to modify the facsimile document after viewing it.

10. The method of claim 1, further comprising facilitating transmission of the facsimile document to a transmission device that will fax the facsimile document.

11. A system for manipulating data to be faxed to an intended recipient, comprising:
means for obtaining data to be included in a facsimile document;
means for automatically determining the total number of pages of the facsimile document; and
means for facilitating transmission of the facsimile document to a transmission device that will fax the facsimile document.

12. The system of claim 11, further comprising means for generating a facsimile cover page.

13. The system of claim 12, further comprising means for automatically including an indication of the number of pages the facsimile document has on the facsimile cover page.

14. The system of claim 11, further comprising means for presenting the facsimile document to the user for review prior to transmission of the facsimile document.

15. A facsimile control program stored on a computer-readable medium, comprising:
logic configured to obtain data to be included in a facsimile document; and
logic configured to automatically determine the total number of pages of the facsimile document.

16. The program of claim 15, further comprising logic configured to generate a facsimile cover page.

17. The program of claim 15, further comprising logic configured to automatically include an indication of the number of pages the facsimile document has on the facsimile cover page.

18. The program of claim 15, further comprising logic configured to present the facsimile document to the user for review prior to transmission of the facsimile document.

19. The program of claim 15, further comprising logic configured to facilitate transmission of the facsimile document to a transmission device that will fax the facsimile document.

20. A transmission device, comprising:
a processing device;
device operation hardware; and
memory comprising a data upload module that is configured to facilitate transmission of scanned data to a facsimile control program executing on a host so that the total number of pages of a facsimile document can be determined and so that the document can be previewed prior to its transmission.

21. The transmission device of claim 20, wherein the transmission device is a multi-function peripheral (MFP).

22. The transmission device of claim 20, wherein the transmission device is an all-in-one device.

23. A method for manipulating data to be faxed to an intended recipient, comprising:
obtaining data to be included in a facsimile document;
automatically determining the total number of pages of the facsimile document; and
automatically generating a facsimile cover page that includes an indication of the number of pages the facsimile document includes.

24. The method of claim 23, further comprising presenting the facsimile document to the user for review prior to transmitting the facsimile document.

25. The method of claim 24, further comprising permitting the user to modify the facsimile document after viewing it.

26. The method of claim 23, wherein the step of obtaining data comprises obtaining data from multiple data sources.

27. The method of claim 26, wherein the step of automatically determining the total number of pages comprises automatically determining the total number of pages of all data received from the multiple data sources.

28. The method of claim 23, further comprising facilitating transmission of the facsimile document to a transmission device that will fax the facsimile document.

29. A method for manipulating data to be faxed to an intended recipient, comprising:
obtaining data to be included in a facsimile document;
automatically determining the total number of pages of the facsimile document; and
presenting the facsimile document to the user for review prior to transmitting the facsimile document.

30. The method of claim 29, further comprising permitting the user to modify the facsimile document after viewing it.

31. The method of claim 29, wherein the step of obtaining data comprises obtaining data from multiple data sources.

32. The method of claim 29, wherein the step of automatically determining the total number of pages comprises automatically determining the total number of pages of all data received from the multiple data sources.

33. The method of claim 29, further comprising facilitating transmission of the facsimile document to a transmission device that will fax the facsimile document.

34. A method for manipulating data to be faxed to an intended recipient, comprising:
obtaining data to be included in a facsimile document;
automatically determining the total number of pages of the facsimile document;
automatically generating a facsimile cover page that includes an indication of the number of pages the facsimile document has;
presenting the facsimile document including the facsimile cover page to the user for review prior to transmitting the facsimile document; and
permitting the user to modify the facsimile document after viewing it.

35. A facsimile control program stored on a computer-readable medium, comprising:
logic configured to obtain data to be included in a facsimile document;
logic configured to automatically determine the total number of pages of the facsimile document; and
logic configured to automatically generate a facsimile cover page that includes an indication of the number of pages the facsimile document includes.

36. The program of claim 35, further comprising logic configured to present the facsimile document to the user for review prior to transmitting the facsimile document.

37. A facsimile control program stored on a computer-readable medium, comprising:
logic configured to obtain data to be included in a facsimile document;
logic configured to automatically determine the total number of pages of the facsimile document; and
logic configured to present the facsimile document to the user for review prior to transmitting the facsimile document.

38. The program of claim 37, further comprising logic configured to permit the user to modify the facsimile document after viewing it.
